(19) United States
(12) Patent Application Publication
(10) Pub. No.: US 2023/0384134 A1
(43) Pub. Date: Nov. 30, 2023

(54) CORIOLIS FLOWMETER AND METHOD FOR OPERATING THE CORIOLIS FLOWMETER

(71) Applicants: Thomas Chatzikonstantinou, Aachen (DE); HEINRICHS MESSTECHNIK GMBH, Köln (DE)

(72) Inventor: Thomas Chatzikonstantinou, Aachen (DE)

(21) Appl. No.: 18/027,645

(22) PCT Filed: Sep. 22, 2021
(86) PCT No.: PCT/EP2021/076037

§ 371 Date: Mar. 22, 2023

(30) Foreign Application Priority Data
Sep. 23, 2020 (EP) 20197928.3

(51) Int. Cl. G01F 1/84; G01F 1/86

(52) U.S. Cl. CPC G01F 1/8413; G01F 1/8431; G01F 1/8495; G01F 1/86

(57) ABSTRACT

A coriolis flowmeter, comprising a measurement device inlet and a measurement device outlet for a fluid, at least one directly measuring direct measuring tube (8, 9) with at least one oscillation generator (25) and at least two oscillation sensors (26, 27), at least one indirectly measuring indirect measuring tube (10) with an indirect measuring tube outlet (23) and at least one flow divider (13) arranged downstream of the measurement device inlet and upstream of the at least one direct measuring tube (8, 9) and the at least one indirect measuring tube (10) in the flow direction, is characterized in that the at least one direct measuring tube (8, 9) opens directly or indirectly into the indirect measuring tube (10) or one of the indirect measuring tubes (10) upstream of the indirect measuring tube outlet (23) in the flow direction. A method for operating a coriolis throughflow measurement device is also proposed.

The invention relates to a Coriolis flowmeter in accordance with the preamble of claim 1 and to a method for operating the Coriolis flowmeter.

Apparatuses for Coriolis throughflow measurement are well known from the prior art (see, for example, DE 20 2017 006 709 U1) and are used, in particular, to determine the mass throughput and/or the density of a fluid flowing through. In a measuring transducer, Coriolis flowmeters have at least one measuring tube which is flowed through by the fluid, the mass throughput and/or density of which are/is to be determined. The at least one measuring tube is set vibrating by means of a vibration generator, while at the same time the vibrations of the measuring tube are measured by means of vibration sensors at measuring points which are separated from one another. If no fluid flows through the measuring tube during the measurement, the measuring tube vibrates with an identical phase at the two measuring points. In the case of fluid flowing through, in contrast, phase shifts occur at the two measuring points on account of Coriolis forces which occur, which phase shifts are a direct measure of the mass throughput Q, that is to say the mass of the fluid flowing through per unit time, through the relevant measuring tube. In addition, the eigenfrequency of the measuring tube at the measuring points is directly dependent on the density of the fluid flowing through, with the result that its density can likewise be determined.

FIG. 1 shows a perspective view of a Coriolis flowmeter in accordance with the abovementioned prior art which is provided, for example, for measuring a mass throughflow in a fluid line. In order to make a view of the interior possible, parts of the housing and connector lines for the fluid, connector cables for electricity and data, and the evaluation electronics are not shown in FIG. 1. A flow divider 2 is arranged downstream of a fluid inlet 1 in the flow direction, which fluid inlet 1 is provided for connection to the fluid pipeline (not shown here), which flow divider 2 divides the fluid flow among two directly measuring measuring tubes 3 and 4. The measuring tubes 3 and 4 are excited to perform vibrations by means of a vibration generator arrangement 5. In the case of a fluid flowing through, Coriolis forces generate a phase shift in the vibration movements of each of the measuring tubes 3 and 4 which are determined by way of vibration sensor arrangement 6 and 7. The measuring tubes 3 and 4 open into a fluid outlet which is not visible in the illustration and in which the fluid flows of the two measuring tubes 3 and 4 merge and pass back into the fluid pipeline.

If Coriolis flowmeters are used for high fluid pressures, they as a rule have particularly thick-walled measuring tubes. Already for the measurement of moderate throughflows in the order of magnitude of, for example, at most 1.5 tons/hour at 1000 bar which, in accordance with the pressure equipment directives, presuppose a test pressure 1.5 times higher, that is to say 1500 bar, measuring tubes which have an external diameter in the order of magnitude of 12 mm and a wall thickness of at least 3 mm have to be used. With such a rigid tube cross section, the measuring tubes and, as a consequence, also the entire unit have to have dimensions in the order of magnitude of 1 m, in order to generate sufficient phase shifts and therefore measuring signals. As a result, the installation complexity increases considerably, even for moderate throughflows of this type. In addition, great lengths in the case of the measuring tubes have impaired dynamic properties as a consequence, which is perceivable as a result of lower measuring accuracy, reproducibility and an imprecise zero point of the measuring unit.

Moreover, this results in a greater pressure loss within the measuring unit. The abovementioned problems of Coriolis flowmeters at high fluid pressures, for example in the order of magnitude of 1000 bar or even more, are considered unavoidable in the prior art.

In addition, Coriolis flowmeters with large dimensions lead to the vibrations of the measuring tubes leading to resonating of the surrounding air and therefore to various aero-acoustic effects which can be loud and disruptive during operation. The abovementioned problems increase with increasing dimensions of the Coriolis flowmeters, in particular in the case of measuring units which are configured for measurements of throughflows in the order of magnitude of, for example, 2000 tons/hour. In the case of a direct connection to large pipelines, the consequences are correspondingly large dimensions of the measuring unit in the order of magnitude of 2 m, the high weight thereof in the order of magnitude of 1 ton, and high installation complexity.

DE 10 2016 118 016 A1 has disclosed a Coriolis flowmeter of the type mentioned at the outset which has low installation complexity and a low installation length even in the case of high fluid throughflows. This unit is a Coriolis flowmeter in accordance with what is known as “bypass technology” which can be connected directly to a pipeline. The unit divides the fluid flow, the throughflow of which is to be measured, into two or more partial flows. The partial throughflow in at least one direct measuring tube is measured directly by means of vibration generators and vibration sensors, while the remaining throughflow flows through at least one indirect measuring tube, to which no vibrations are imparted. The overall throughflow is then determined from the directly measured part throughflow by means of a conversion factor which takes the geometries of all the tubes into consideration. In the case of this Coriolis flowmeter, the individual partial flows do not influence one another, on account of the separate configuration of the tubes, which can lead to serious disadvantages. It is known, for example, that flowmeters and, in particular, Coriolis flowmeters which utilize the bypass technology become less precise the smaller the partial throughflow through the at least one direct measuring tube is. In the case of the previously mentioned prior art in accordance with DE 10 2016 118 016 A1, a sufficient partial throughflow passes through the at least one direct measuring tube for a sufficiently precise measurement only when the other tubes have the same diameter and the same length. However, in order to be able to design a Coriolis flowmeter suitable for direct connection to large pipelines, these tubes must be very numerous, which greatly increases the pressure loss in the device, which in turn is associated with an undesirably high energy loss.

DE 10 2016 118 016 A1 which has already been mentioned also discloses embodiments, in the case of which the diameter of the at least one indirect measuring tube considerably exceeds that of the at least one direct measuring tube, with the result that the overall pressure loss of the measuring unit and the overall number of measuring tubes can be kept low. Since fluids follow the path of least resistance, the consequence of this without special measures would be that such a low proportion of the fluid flow flows through the direct measuring tube that the measuring accuracy can be unsatisfactory, in particular in the lower measuring range of the measuring unit.

Furthermore, the determination of the overall throughflow takes place by means of a conversion factor which takes into consideration the geometries of the at least two measuring tubes. The possible influence of the parameters of viscosity, temperature and pressure of the fluid and the dependence of the conversion factor on the instantaneous overall throughflow on the measured result is not mentioned in DE 10 2016 118 016 A1, whereby there are further factors for imprecise measured results. Dependence of the conversion factor on the instantaneous overall throughflow can be ignored only in the case of the particularly unfavorable embodiment with a plurality of tubes of identical diameter. This case leads to a high pressure and energy loss, as mentioned above, however, and therefore can be less practicable.

In particular, it is not taken into consideration in DE 10 2016 118 016 A1 that what is known as the bypass ratio, that is to say the ratio between the throughflow through the at least one direct measuring tube and the overall throughflow, is not a purely geometric variable and is therefore in no way constant over the measuring range of the unit. The bypass ratio is actually dependent on the instantaneous overall throughflow and/or on the viscosity, temperature and/or pressure of the fluid to be measured. It seems likely that units which are configured in accordance with the principles of the prior art according to DE 10 2016 116 016 A1 have up to now not achieved a breakthrough in the market for the stated reasons.

The older documents U.S. Pat. No. 9,080,908 B2 and DE 10 2008 002 217 A1 do not provide a remedy for solving the above-described problems. U.S. Pat. No. 9,080,908 B2 addresses the problem that measuring tubes which are provided for Coriolis flowmeters are limited with regard to their diameter and accordingly, at the time of this document, 70% of the Coriolis flowmeters were sold with direct measuring tubes of a diameter of two inches or less. As a solution, it is proposed for at least one direct measuring tube which is flowed through by a partial flow of the fluid to be provided within an outer cylindrical tube, through which the fluid flows and which receives the diameter of the supplying fluid pipeline. That is to say, the direct measuring tube is flowed around by the majority of the fluid. According to this document, this solution is also feasible, inter alia, for measurements in accordance with the principle of Coriolis throughflow measurement. It is disadvantageous, however, that power or data lines which are required for the measurement have to be routed through the outer tube. Although a calibration is addressed, the dependence of the factor for conversion from the measured result of the direct measuring tube to the overall throughflow on the overall throughflow itself and/or on the viscosity, temperature and/or pressure is, however, not addressed.

DE 10 2008 002 217 A1 discloses one variant, in the case of which, for Coriolis throughflow measurement, the measuring tube is divided into two partial measuring tubes by way of a centrally running dividing wall, the two parts having identical cross sections. The measuring tube can have the same external diameter as the fluid pipeline, with the result that a flange is not required. Calibration is not addressed.

DE 20 2014 102 258 U1 has disclosed a further Coriolis flowmeter which utilizes the bypass technology. As in the case of DE 10 2016 118 016 A1, the throughflow to be measured is divided into two or more partial throughflows by way of a corresponding number of tubes. The partial throughflow is measured directly in a direct measuring tube, and the overall throughflow is then specified from this directly measured partial throughflow value by means of a conversion factor. The individual partial flows do not influence each other in the case of this Coriolis flowmeter either, on account of the separate configuration of the tubes. If the part throughflow through the direct measuring tube is low in relation to the overall throughflow, it is to be expected that little to no part throughflow at all flows through the direct measuring tube here either without special measures, for which reason the problems which have already been addressed above are not solved.

U.S. Pat. No. 5,861,561 also teaches the application of bypass technology in combination with a directly measuring flowmeter which can also be a Coriolis flowmeter. The Coriolis flowmeter can be installed both outside a main line and in a main line. In the case of the embodiment with a direct measuring tube arranged outside the indirect measuring tube, however, the inlet for the direct measuring tube is placed into the indirect measuring tube.

As a result of the embodiment of the external directly measuring flowmeter in accordance with the teaching of U.S. Pat. No. 5,861,561, problems can occur at the inlet to the direct measuring tube on account of possible flow separations and pressure gradients which can even lead to blockages, for example as a result of compression shocks in the case of gases. The likewise proposed variant of the installation of the directly measuring flowmeter into the main line is disadvantageous because the limited space does not make it possible to use U-shaped measuring tubes with higher measuring sensitivity.

The electric/electronic connection to the outside is not possible either without leadthroughs and flow separations arising at them. The possibility of the simple and compact connection of a measuring unit in accordance with the teaching of U.S. Pat. No. 5,861,561 is not disclosed.

U.S. Pat. No. 5,661,232 A discloses a measuring method with the use of two flowmeters which are combined for the measurement, the throughflow through the measuring tube of one of the measuring units being reduced in comparison with that of the other measuring unit, either on account of different diameters of the measuring tubes or outlets of different design of the measuring tubes. In one embodiment, the two measuring units are connected to a fluid line via a common inlet and a common outlet, the fluid flow being divided completely among the two measuring units. In an alternative solution, the process is carried out using the bypass method, however, merely partial fluid flows being branched off from a main fluid line which does not belong to the measuring units. This takes place by either a common inlet for the two measuring units being laid into the interior of the fluid main line or the two measuring units being connected separately to the fluid main line, which can in turn lead to the above-addressed problems in conjunction with too low a flow through the measuring lines for precise measurements. In addition, it is disadvantageous that two separate measuring units are required for the solution shown in the prior art.

Based on this prior art, the technical object of this invention consists in providing a method and an apparatus for determining a flow parameter by means of a Coriolis flowmeter for high pressures and/or for direct connection to large pipelines, which method and apparatus make high accuracy over the entire measuring range possible. Furthermore, there is intended to be preferably as low a pressure loss as possible during the measurement and a low acoustic level even at high throughflow rates.

In the case of a Coriolis flowmeter of the type mentioned at the outset, the technical object is achieved by way of the characterizing features of claim 1, and in the case of a method of the type mentioned at the outset by way of the features of claim 7.

Advantageous embodiments of the apparatus according to the invention and of the method according to the invention result from the respective dependent claims.

The present invention uses the terms of direct measuring tube and indirect measuring tube. The direct measuring tube is set in vibration and measures the throughflow of a fluid in accordance with the Coriolis measuring principle. In contrast to this, in the case of the indirect measuring tube, no Coriolis forces are measured during throughflow of the fluid, for which reason the fluid throughflow can be measured solely in cooperation with one or more direct measuring tubes.

According to the invention, in the case of a Coriolis flowmeter, comprising a measuring unit inlet and a measuring unit outlet for a fluid, at least one directly measuring direct measuring tube with at least one vibration generator and at least two vibration sensors, at least one indirectly measuring indirect measuring tube with an indirect measuring tube outlet, and at least one flow divider which is arranged downstream of the measuring unit inlet and upstream of the at least one direct measuring tube and the at least one indirect measuring tube in the flow direction, it is proposed that the at least one direct measuring tube opens directly or indirectly into the indirect measuring tube or one of the indirect measuring tubes upstream of the indirect measuring tube outlet in the flow direction.

The fluid flow in the indirect measuring tube ensures a negative pressure at the opening point of the at least one direct measuring tube or, if the relevant indirect measuring tube opens indirectly in the relevant indirect measuring tube, at the opening point of an intermediate piece, for example an end piece, as will be described further below. As a result, a sufficient throughflow through the at least one direct measuring tube and therefore a satisfactory accuracy of the measurement of the overall throughflow Q_{ALL} over the entire measuring range of the measuring unit can be achieved. The at least one direct measuring tube and the at least one indirect measuring tube are part of a Coriolis flowmeter which can be connected to a fluid main line. For this purpose, the Coriolis flowmeter preferably has connector apparatuses, for example flanges, for installation into a fluid line.

In the following text, advantageous and exemplary embodiments of the Coriolis flowmeter according to the invention and of the method according to the invention will be shown on the basis of figures, in which, diagrammatically:

FIG. 1 shows in perspective a Coriolis flowmeter in accordance with the prior art,

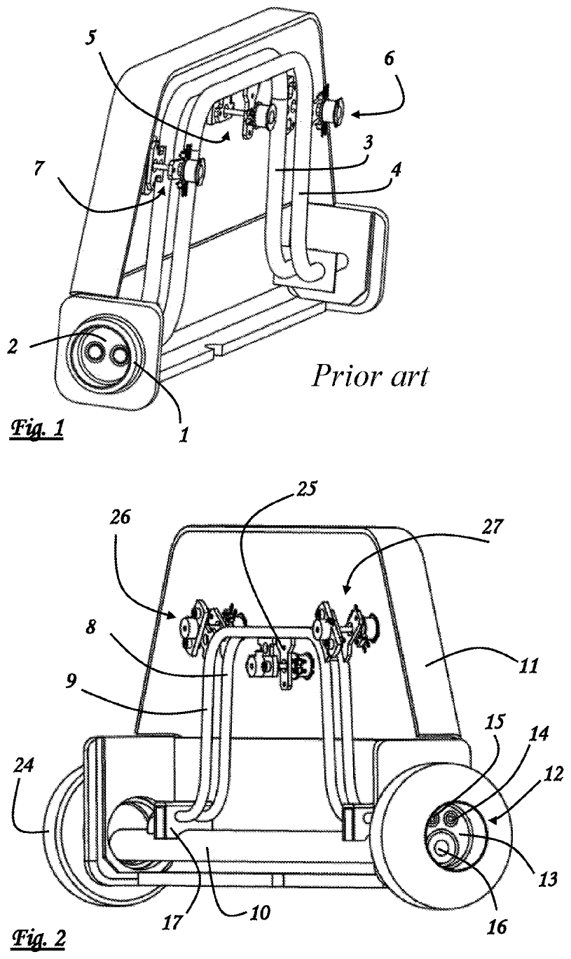

FIG. 2 shows in perspective and in parts, a first embodiment of a Coriolis flowmeter according to the invention,

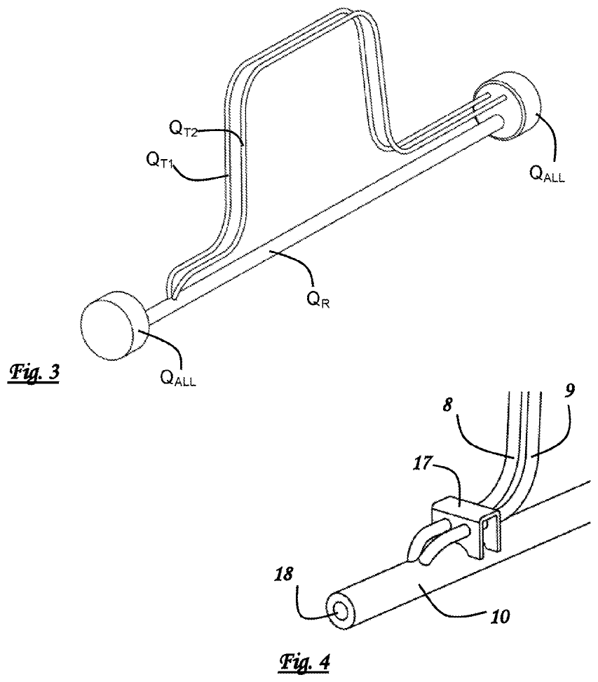

FIG. 3 shows fluid flows in the Coriolis flowmeter according to FIG. 2,

FIG. 4 shows details of the opening of direct measuring tubes into an indirect measuring tube of the Coriolis flowmeter according to FIG. 2,

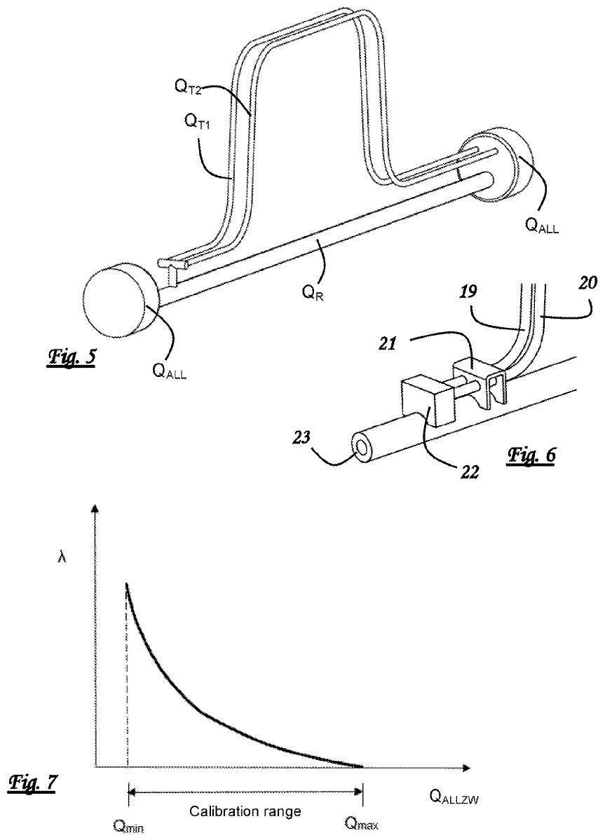

FIG. 5 shows fluid flows in a second embodiment of the Coriolis flowmeter according to the invention,

FIG. 6 shows details of the opening of direct measuring tubes into an indirect measuring tube of the second embodiment, and

FIG. 7 shows a diagram relating to the dependence of the factor λ on the fluid throughflow through the direct measuring tubes.

A Coriolis flowmeter in accordance with the prior art, as shown in FIG. 1, has already been described further above. In contrast, FIG. 2 shows in perspective, as an example, a first Coriolis flowmeter in accordance with the present invention with a first direct measuring tube 8, a second direct measuring tube 9 and an indirect measuring tube 10. The inventive technology which is described using the example shown here can be used in a corresponding way in the case of other designs of a Coriolis flowmeter, for example with only one direct measuring tube or more than two direct measuring tubes and/or with more than one indirect measuring tube and/or different sensor technology.

In order to make a view into the interior of the unit possible, parts of a housing 11, process connectors, junction plates, connector cables and possibly evaluation electronics are not shown in FIG. 2. FIG. 3 diagrammatically visualizes the fluid throughflows through the first Coriolis flowmeter without the associated tubes. There is therefore a view of the fluid.

The first Coriolis flowmeter is flange-connected to a fluid pipe (not shown here), with the result that fluid which exits from the fluid pipe passes into a fluid inlet 12 of the first Coriolis flowmeter and meets a flow divider 13. Via a first direct measuring tube inlet 14 (FIG. 2), a first partial throughflow Q-T passes into the first direct measuring tube 8, and a second partial throughflow Q_{T2} passes via a second direct measuring tube inlet 15 into the second direct measuring tube 9. Via an indirect measuring tube inlet 16, the fluid passes with a remaining throughflow Q_{R} into the indirect measuring tube 10. The sum of the partial throughflows Q_{T1} and Q_{T2} with the remaining throughflow Q_{R} results in the overall throughflow Q_{ALL}.

A uniform pressure prevails in the region of the flow divider 13 upstream of the measuring tube inlets 14, 15 and 16, as a result of which all the measuring tubes 8, 9 and 10 are supplied equally.

The two direct measuring tubes 8 and 9 open into the indirect measuring tube 10, as can be seen in FIG. 4, in particular. The opening region is largely concealed by way of a rear junction plate 17 in FIG. 2. The opening of the partial throughflows Q_{T1} and Q_{T2} into the remaining throughflow Q_{R} can be seen in FIG. 3. The merging of the partial throughflows Q_{T1} and Q_{T2} with the remaining throughflow Q_{R} to form the overall throughflow Q_{ALL} takes place upstream of an indirect measuring tube outlet 18 (FIG. 4) in the flow direction, through which indirect measuring tube outlet 18 the overall throughflow Q_{R} is fed via an outlet flange 24 to a fluid pipe (not shown here).

For measurement purposes, the direct measuring tubes 8 and 9 are set in vibration by means of a vibration generator 25, while at the same time the vibrations of the two direct measuring tubes 8 and 9 are measured in each case by means of vibration sensors 26 and 27 at measuring points which are separate from one another. If no fluid flows through the direct measuring tubes 8 and 9 during the measurement, they vibrate in each case with an identical phase at the two measuring points. With fluid flowing through, in contrast, phase shifts occur at the two measuring points on account of Coriolis forces which occur, which phase shifts are a measure not only of the partial throughflows Q_{T1} and Q_{T2} but rather, in combination with the indirect measuring tube 10 in the case of a calculation shown further below, are also a measure of the overall throughflow Q_{ALL}. In addition, the eigenfrequencies, determined at the measuring points of the vibration sensors 26 and 27, of the direct measuring tubes 8 and 9 are dependent on the density of the fluid flowing through, with the result that its density can also be determined. A contribution from the indirectly measuring measuring tube is not necessary to this end.

FIG. 5 diagrammatically and perspectively visualizes the fluid throughflows through a second Coriolis flowmeter (not shown in greater detail here) without the associated tubes. The special feature of this second embodiment of the flowmeter according to the invention consists merely in the fact that the two partial throughflows Q_{T1} and Q_{T2} are combined before they are merged with the remaining throughflow Q_{R}. FIG. 6 shows an enlarged detail of the associated pipework with a first direct measuring tube 19 and a second direct measuring tube 20 of the second Coriolis flowmeter which open into a collecting element 22 after passing a junction plate 21, which collecting element 22 feeds the fluid to the remaining throughflow in the indirect measuring tube 23 before the overall throughflow Q_{R} can exit via an indirect measuring tube outlet 23.

In the following text, the measuring method according to the invention will be explained in greater detail by way of example on the basis of the apparatus which is shown in FIGS. 2 to 4. Insofar as this example mentions two direct measuring tubes 8 and 9 and one indirect measuring tube 10, it goes without saying for a person skilled in the art that this also applies mutatis mutandis in the case of other configurations, that is to say, for example, in the case of the variant according to FIGS. 5 and 6 and also in the case of only one direct measuring tube or more than two direct measuring tubes and/or in the case of two or more indirect measuring tubes.

Because only the direct measuring tubes 8 and 9 can measure in accordance with the Coriolis measuring principle, the overall throughflow Q_{ALL} of actual interest has to be calculated. The measurement is more accurate, the greater the proportion of the directly measured partial throughflows Q_{T1} and Q_{T2} in the overall throughflow Q_{ALL} to be measured, that is to say the greater what is known as the bypass ratio. Here, bypass is understood to mean the throughflow through the direct measuring tubes 8 and 9. The bypass ratio is not constant over the entire measuring range, that is to say from low to high overall throughflows Q_{ALL}. It is thus particularly advantageous not only to have a great proportion of partial throughflows Q_{T1} and Q_{T2} in the case of a defined overall throughflow Q_{ALL}, but rather also to be able to ensure a suitably large bypass ratio over the entire measuring range of the measuring unit. A contribution is made in the way according to the invention by the fact that the direct measuring tubes 8 and 9 open directly (or indirectly in accordance with the variant according to FIGS. 5 and 6) into the indirect measuring tube 10, since, as a result, the partial throughflows Q_{T1} and Q_{T2} are added at the opening not only to the remaining throughflow Q_{R} which arises there. Rather, the fluid flow in the indirect measuring tube 10 ensures a negative pressure at the opening point, which negative pressure can ensure sufficient throughflow through the direct measuring tubes 8 and 9 and therefore satisfactory accuracy of the measurement of the overall throughflow Q_{ALL} over the entire measuring range of the measuring unit.

As a consequence, on account of the increased throughflows through the direct measuring tubes 8 and 9, the diameters and also wall thicknesses of the latter can be kept small. One exemplary embodiment of the Coriolis flowmeter according to the invention with, for example, 1500 kg/h mass throughflow at 1000 bar operating pressure (at, for example, 1500 bar test pressure) can be realized by way of direct measuring tubes with only 4 millimeters of external diameter and a wall thickness of only 1 millimeter. Therefore, the dimensions of the Coriolis flowmeter overall can be kept comparatively small, even in its longitudinal direction, even if there are high fluid throughflows or high fluid pressures, for example if the intention is to be able to measure gases at very high pressures of, for example, 1000 bar and more as occur, for example, during hydrogen filling of vehicles and similar applications. Coriolis flowmeters which can be of more compact overall construction in comparison with Coriolis flowmeters according to the prior art available for identical pressure ranges can therefore be realized by way of the invention, even for very high pressures. By way of the invention, however, Coriolis flowmeters can be realized even for mass throughflows greater by orders of magnitude than the abovementioned 1500 kg/h, which Coriolis flowmeters can be of more compact, more stable-measuring, more smooth running and less expensive overall construction in comparison with Coriolis flowmeters according to the prior art available for identical measuring ranges.

The more compact overall design also entails advantages in terms of measuring technology, since the rigidities of the Coriolis flowmeter and therefore also its zero point stability, measuring accuracy and reproducibility can be improved as a result of the smaller dimensions of the indirect measuring tube 10 in its longitudinal direction possible in the case of measuring units according to the invention.

The acoustics of the Coriolis flowmeters, in particular for the measurement of very high fluid throughflows in the order of magnitude of thousands of tons per hour, also profit from the teaching of the present invention. Since larger direct measuring tubes are as a rule installed in the prior art in comparison with this invention, the air which surrounds the direct measuring tube or the direct measuring tubes is also set in vibration to a more pronounced extent, which can generate loud and disruptive operating noise. In accordance with the teaching according to the invention, smaller external dimensions of the direct measuring tubes 8 and 9 can be provided which transmit a correspondingly smaller amount of vibration energy and therefore ensure lower operating noise.

As a result of the bypass technology, the pressure loss of the fluid in the Coriolis flowmeter is decreased, since the main part of the overall throughflow Q_{ALL}, namely the remaining throughflow Q_{R}, flows through an indirect measuring tube 10 which is short in comparison with the direct measuring tubes 8 and 9 and is provided with a greater internal diameter.

As has already been mentioned, the bypass ratio, that is to say the ratio between the sum of the directly measured partial throughflows Q_{T1} and Q_{T2} and the overall throughflow Q_{ALL}, is not a variable which is defined solely by way of geometry, as it appears to be in accordance with the cited prior art DE 10 2016 118 016 A1, and is therefore in no way constant over the entire measuring range of Q. Rather, the bypass ratio is dependent on the instantaneous overall throughflow Q_{ALL} and on viscosity, temperature and pressure of the fluid to be measured. Analytical formulae from literature which approximately take into consideration at least the viscosity, as taught, for example, by DE 20 2014 102 258 U1, are valid only for very simple geometries, usually only for cylindrical tubes, and cannot even satisfactorily detect fluid-mechanical effects in the measuring units. This fundamental problem is solved by the following invention as follows:

The sum of the partial throughflows Q_{T1} and Q_{T2} in the direct measuring tubes 8 and 9 result in an overall partial throughflow Q_{TG}. In order to arrive at the overall throughflow Q_{ALL}, the remaining throughflow Q_{R} is to be added but is not measured directly. Rather, a first value (called intermediate value Q_{ALLZW} in the following text) for the overall throughflow results from a calibration of the Coriolis flowmeter, as is known fundamentally from the prior art for measuring units without bypass technology. The calibration takes place with a known medium, for example water, under predefined ambient conditions.

In order to take into consideration the dependence of the actual overall throughflow Q_{ALL} on the abovementioned variables, the intermediate value is multiplied by the factor (1+λ), with the result that the following applies:

Q_{ALL}=Q_{ALLZW}*(1+λ).

The variable “Q_{ALLZW}*λ” is therefore factorially that part of the overall throughflow which has not been detected by the unit during its calibration and has to be added. For a unit, the geometry and material of which are known, the factor λ is dependent, in particular, on the mass throughflow Q, but also on the viscosity and initially, furthermore, on pressure and temperature of the fluid to be measured. This represents a characteristic diagram with the viscosity, the pressure and the temperature, it being possible for even the viscosity itself to be dependent on the temperature.

Errors as a result of pressure and temperature can thus be compensated for, however, within the context of a simplified implementation of the present invention, as is already known from the prior art for Coriolis flowmeters without bypass technology. As a result, they can be dispensed with as parameters during the determination of A, as a result of which a substantially simpler characteristic diagram is thus obtained within the context of this simplified implementation, which characteristic diagram specifies merely the relative error A as a function of the intermediate value Q_{ALLZW} which is still faulty, and only has the viscosity as parameter. FIG. 6 qualitatively shows the dependence of the relative error A on the measured intermediate value Q_{ALLZW}, this function still containing the viscosity as a parameter. It is of course also possible to additionally take into consideration the dependence on pressure and temperature.

The dependence on the viscosity can be determined experimentally or by means of simulation and can be used as a characteristic diagram by an evaluation unit (not shown here). The characteristic diagram itself can either have an analytical form or can be present in the form of discrete values, between which interpolation is carried out using interpolation methods.

For the determination of the overall throughflow Q_{ALL}, the partial throughflows Q_{T1} and Q_{T2} and the overall partial throughflow Q_{TG} itself do not have to be determined numerically. Rather, the overall throughflow can be determined directly from the phase shifts measured at the direct measuring tubes 8 and 9 with consideration of the calibration and the characteristic diagram.

The determination of the characteristic diagram by means of simulation is advantageous, in particular, in the case of fluid-structure interaction simulations (customary abbreviation in CAE literature: FSI simulations). The simulation can take place outside the Coriolis flowmeter according to the invention, in order to transfer the characteristic diagram which is produced in this way into an evaluation unit of the Coriolis flowmeter, for example via a suitable interface, a local network, the Internet or other connection possibilities. The simulation can also take place in the evaluation unit itself, however.

As has already been mentioned, the characteristic diagram can be supplemented by way of interpolation methods, with the result that the experimental or simulation-based determination of a limited number of discrete values can be sufficient. It can be particularly advantageous to at least also use Kriging as interpolation method.

Kriging is an interpolation method tracing back to Danie Krige which is known in the prior art in conjunction with geostatistical methods and outside geostatistics as Gaussian process regression. In geostatistics, stochastic methods are used to characterize and estimate data, for example in order to determine the distribution of surface temperatures in land areas or bodies of water. For this purpose, measured values are detected at individual points of the area to be examined, which measured values are then utilized as starting points for a spatial interpolation. Any desired number of estimated values which are intended to depict reality as accurately as possible can thus be determined from a finite number of measured values.

In the case of the Kriging method, the spatial variance is taken into consideration in geostatistics, for the determination of which spatial variance semivariograms are used. Here, the measured values used for the calculation are weighted in such a way that the estimation error variance is as small as possible, which is a particular advantage with regard to the accuracy of the estimation of the intermediate values in comparison with other interpolation methods. By way of Kriging, a higher accuracy can as a rule be achieved, in particular in the case of a low number of data points, that is to say in the case of a small basic data set, in comparison with other interpolation methods, in particular even with regard to higher-order polynomials.

The result of Kriging cannot be specified in a closed form, for example as a polynomial, however, unlike what is possible in alternative interpolation methods. Kriging is complicated and as a rule uses inversion and multiplication of a plurality of matrices. Since Kriging is therefore very CPU-intensive and memory-intensive, resolving a low-resolution basic data set by means of Kriging to become as high-resolution as desired should be avoided. Rather, it can be advantageous for a procedure which is optimized with regard to time and memory requirement to obtain a refined matrix from the basic data set by means of Kriging in a first stage, for example refined by the factor 5, 10 or 100, and to use other, less complicated interpolation methods for further refining between the values obtained by means of Kriging. The result of the less complicated interpolation methods can then in turn be specified in a closed form, for example in a linear manner.

As a result of the type of calibration carried out in accordance with the present invention, the remaining throughflow Q_{R} is no longer a simple operand, but rather also takes part in the determination of the unit parameters as a result of its contribution during the calibration. It is therefore correct to also denote the indirect measuring tube 10 as a measuring tube.

For this reason but also because the experimental or simulation-based determination of the characteristic diagram and, in particular, also because the determination of the characteristic diagram by means of fluid-structure interaction simulations is substantially more accurate than the arithmetic calculation of the overall throughflow by means of mere geometric correlations of the diameters of the measuring tubes or by way of greatly restricted analytical (approximation) formulae, more precise measured results can be achieved than in the prior art.

The present invention also comprises the measuring of an overall throughflow Q by way of a plurality of Coriolis flowmeters in accordance with the present invention which are connected in parallel. This also applies to the case where all the directly and indirectly measuring measuring tubes of these units emanate from a common flow divider, and all the indirectly measuring measuring tubes lead to a common outlet.

In the case of the present invention, the determination of the density of the fluid to be measured is also possible by way of measurement of the eigenfrequency of the direct measuring tube, in the same way as in the case of normal Coriolis flowmeters. Therefore, the volumetric throughflow can also be calculated from density and mass throughflow and output in the evaluation electronics.

### LIST OF DESIGNATIONS

1 Fluid inlet
2 Flow divider
3 Measuring tube
4 Measuring tube
5 Vibration generator arrangement
6 Vibration sensor arrangement
7 Vibration sensor arrangement
8 First direct measuring tube
9 Second direct measuring tube
10 Indirect measuring tube
11 Housing
12 Fluid inlet
13 Flow divider
14 First direct measuring tube inlet
15 Second direct measuring tube inlet
16 Indirect measuring tube inlet
17 Coupling element
18 Indirect measuring tube outlet
19 First direct measuring tube
20 Second direct measuring tube
21 Coupling element
22 Collecting element
23 Indirect measuring tube outlet
24 Outlet flange
25 Vibration generator
26 Vibration sensor
27 Vibration sensor

1. A Coriolis flowmeter, comprising
a) a measuring unit inlet and a measuring unit outlet for a fluid,
b) at least one directly measuring direct measuring tube with at least one vibration generator and at least two vibration sensors,
c) at least one indirectly measuring indirect measuring tube with an indirect measuring tube outlet, and
d) at least one flow divider which is arranged downstream of the measuring unit inlet and upstream of the at least one direct measuring tube and the at least one indirect measuring tube in the flow direction,
characterized in that
e) the at least one direct measuring tube opens directly or indirectly into the indirect measuring tube or one of the indirect measuring tubes upstream of the indirect measuring tube outlet in the flow direction.

2. The Coriolis flowmeter as claimed in claim 1, characterized in that at least two direct measuring tubes are assigned to the indirect measuring tube or to precisely one of the indirect measuring tubes.

3. The Coriolis flowmeter as claimed in claim 2, characterized in that at least two of the direct measuring tubes individually open directly into the associated indirect measuring tube.

4. The Coriolis flowmeter as claimed in claim 2, characterized in that at least two of the direct measuring tubes open indirectly into the associated indirect measuring tube, by the at least two of the direct measuring tubes being merged in a common end piece, the end piece opening into the associated indirect measuring tube.

5. The Coriolis flowmeter as claimed in claim 1, characterized in that it has a measuring unit electronic unit which is configured to use an equation of the form Q_{ALL}=(1+λ)*Q_{ALLZW} to determine the actual mass throughflow Q_{ALL} of the fluid during a throughflow measurement, Q_{ALLZW} being a mass throughflow which is determined by way of the Coriolis flowmeter, and λ being a factor which is dependent on the mass throughflow and at least on the viscosity.

6. The Coriolis flowmeter as claimed in claim 5, characterized in that the factor λ is stored as a characteristic diagram in the electronic evaluation unit, the characteristic diagram either having an analytical form or being present in the form of discrete values.

7. A method for operating a Coriolis flowmeter, in the case of which method a fluid flow is divided into at least one direct measuring flow and at least one indirect measuring flow by means of a flow divider which is arranged downstream of a measuring unit inlet in the flow direction, each direct measuring flow flowing through a direct measuring tube for measurement by means of the Coriolis throughflow measuring method, and each indirect measuring flow flowing through an indirect measuring tube, and the at least one direct measuring flow being introduced into the indirect measuring flow or into at least one of the indirect measuring flows.

8. The method as claimed in claim 7, characterized in that at least two direct measuring flows are assigned to the indirect measuring flow or one of the indirect measuring flows, the at least two direct measuring flows being fed individually or, after merging, jointly to the associated indirect measuring flow.

9. The method as claimed in claim 7, characterized in that an overall flow mass throughflow Q_{ALL} is determined from the measured values with respect to each direct measuring flow with consideration of a variable which is dependent on mass throughflow and viscosity and optionally on pressure and temperature, the overall flow mass throughflow Q_{ALL} being determined by means of the formula Q_{ALL}=(1+λ)*Q_{ALLZW}, λ being a variable which is dependent on the mass throughflow and the viscosity and optionally on pressure and temperature, and Q_{ALLZW} being an intermediate variable for the sum of the direct measuring flows and the at least one indirect measuring flow.

10. The method as claimed in claim 9, characterized in that the variable λ which is dependent on the mass throughflow and the viscosity and optionally on pressure and temperature is determined experimentally.

11. The method as claimed in claim 9, characterized in that the variable λ which is dependent on the mass throughflow and the viscosity and optionally on pressure and temperature is determined by means of simulated calculation.

12. The method as claimed in claim 9, characterized in that the variable λ which is dependent on the mass throughflow and the viscosity and optionally on pressure and temperature is stored as a characteristic diagram in the electronic evaluation unit.

13. The method as claimed in claim 12, characterized in that the characteristic diagram has an analytical form.

14. The method as claimed in claim 12, characterized in that the characteristic diagram is present in the form of discrete values, between which interpolation is carried out using interpolation methods.

15. The method as claimed in claim 14, characterized in that interpellation is carried out by means of Kriging method.
